(19) United States
(12) Patent Application Publication
(10) Pub. No.: US 2009/0213686 A1
(43) Pub. Date: Aug. 27, 2009

(54) Method and Apparatus for Feeding Gaseous or Liquid Fluid into a Medium

(75) Inventors: Toni Heikkilae, Kotka (FI); Vesa Vikman, Kymi (FI)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SULZER PUMPEN AG, WINTERTHUR (CH)

(21) Appl. No.: 11/883,537

(22) PCT Filed: Jan. 13, 2006
(86) PCT No.: PCT/CH06/00034

§ 371 Date: Apr. 16, 2009

(51) Int. Cl. B01F 5/12; F04D 7/02; F04D 29/66; B01F 5/10

(52) U.S. Cl. 366/164.6; 415/203; 415/119

(57) ABSTRACT

The present invention relates to a method of and an apparatus for feeding gaseous or liquid fluid into a medium. The method and apparatus in accordance with the present invention are especially suitable in various fields of industry for mixing gaseous and liquid chemicals and steams into a flow containing at least liquid. The method and apparatus in accordance with the present invention are most preferably suitable for feeding steam into the fiber suspensions of wood processing industry. Most preferably the method and apparatus in accordance with the present invention is used, for example, in such a way that a side flow is taken from a first medium flowing along a suction duct (16) of a centrifugal pump (10), which side flow is recirculated by means of a conduit (18) and into which second medium is fed via a duct (24) in such a way that said side flow and second medium are fed into said first medium flowing in the suction duct (16) prior to taking said side flow from said first medium in view of the main flow direction of said first medium.

The present invention relates to a method of and an apparatus for feeding gaseous or liquid fluid into a medium. The method and apparatus in accordance with the present invention are suitable in various fields of industry for mixing gaseous and liquid chemicals and steams into a flow containing at least liquid. The method and apparatus in accordance with the present invention are especially suitable for feeding steam into the fiber suspensions of wood processing industry.

There are a large number of different known methods and apparatuses for feeding chemicals to liquid flow. The apparatuses are divided into two basic types: static and dynamic. In static apparatuses, at its simplest chemical is allowed to be discharged through an opening in a wall of a flow duct to the flow, to which the chemical mixes in the course of time due to turbulence. In static mixers, various perforated plates or porous rings are used, too, through which especially gaseous chemicals, such as oxygen or ozone, are fed into the flow. The idea is thereby to feed the chemical in as small droplets to the flow as possible, whereby it would mix into the flow more rapidly and more homogeneously. Furthermore, with static mixers, it is possible to use also flow restrictors arranged inside the flow channel, by means of which turbulence greater than the usual duct flow is caused in the flow, which naturally facilitates the mixing of chemicals leading to a quicker and more homogeneous mixing.

With dynamic mixers, the mixing generally takes place by means of some kind of a rotary apparatus. Said apparatus is located in the flow duct and the chemical is supplied either via the rotary apparatus or upstream thereof into the flowing medium. Rotary mixers are exemplified, for example, by apparatuses in accordance with the following patents: U.S. Pat. No. 5,279,709, U.S. Pat. No. 5,536,368, U.S. Pat. No. 5,378,321, and U.S. Pat. No. 6,791,778. All disclosed apparatuses are designed especially for mixing, which can be understandable as such, because at the time the apparatuses were developed, ozone was becoming a popular bleaching chemical in bleaching pulps of wood processing industry and mixers were developed especially keeping the special features of ozone in mind.

It has, however, been noticed now that as for the mixing speed, the majority of the chemicals or like materials to be mixed are not so demanding. In other words, it has been noticed that it is not necessary to use separate apparatuses especially designed for the mixing, but mixing of most of the chemicals can be performed by a centrifugal pump so that the centrifugal pump as such acts as mixer.

At least some of the patents or patent applications suggest the centrifugal pump to be used for mixing chemicals or like. The suggestions have not, however, always led to practical applications. One of the patents suggesting the use of pump for mixing is U.S. Pat. No. 4,834,547, in which the volute of the pump is extended to the rear side of the impeller in such a way that the chemical to be added can be supplied to the rear side of the impeller and be mixed there with the medium circulating in the volute by means of specific rear vanes arranged into communication with the impeller. Said patent is especially concerned about adding chemical into a medium consistency pulp.

Patent application F1 823279 also discusses adding chemical into a medium consistency pulp in a pump. In this arrangement, chemical is added through a conduit in a wall of a suction duct of a fluidizing centrifugal pump into the pulp flowing in said suction duct. The solution in accordance with said patent application is used when the chemical to be mixed is liquid, whereby it does not affect the pumping.

The pump structure discussed in the first mentioned publication is unnecessarily complicated to be competitively manufactured. On the other hand, also the feeding point of the chemical relative to the mixing vanes is not at all ideal. It can even be doubted, whether the disclosed structure allows proper mixing at all; at least not with simple structural changes.

Neither of the structures in the disclosed publications works when mixing, for example, steam into pulp, because in both cases steam would heavily disturb the pumping of the pulp. The main reason for the steam disturbing the pumping is that the steam does not have time to condense before it enters into contact with the impeller of the pump. In other words, the steam gathers into the eye of the impeller of the pump and either forces the impeller to work at least partially in a gas bubble or exits through the gas discharge of the pump, if such exists in the pump, or causes cavitation in the pump.

A purpose of the present invention is to eliminate drawbacks of the prior art solutions by a very simple apparatus, which is inexpensive to manufacture, and by means of which, for example, following advantages may be achieved:
separate mixer with its drive, base plate, etc. is not needed anymore;
pump acts as mixer;
mixing does not, in practice, increase consumption of energy at all;
steam may be mixed into pulp without a separate mixer; and
steam may be of low pressure.

In accordance with the present invention, it is typical of a method of mixing a second medium into a first medium, in which method said first medium is allowed to flow along a suction duct into a centrifugal pump, where the pressure of the medium is raised and the medium is discharged from the pump, that a side flow is taken from said first medium, which side flow is recirculated and into which second medium is fed in such a manner that said side flow and second medium are fed into said first medium prior to taking said side flow from said first medium in view of the main flow direction of said first medium.

In accordance with the present invention, it is typical of an apparatus for feeding a second medium into a first medium, said apparatus comprising a centrifugal pump with an impeller, a volute and a suction duct as well as an inlet conduit for said second medium, that a recirculation duct for a first medium is arranged into communication with said suction duct or with a front wall of said volute, in which recirculation duct said inlet conduit is located.

Other characterizing features of the method and apparatus in accordance with the invention become apparent in the accompanying claims.

The method and apparatus in accordance with the present invention are discussed more in detail by way of example with reference to the accompanying drawings, in which

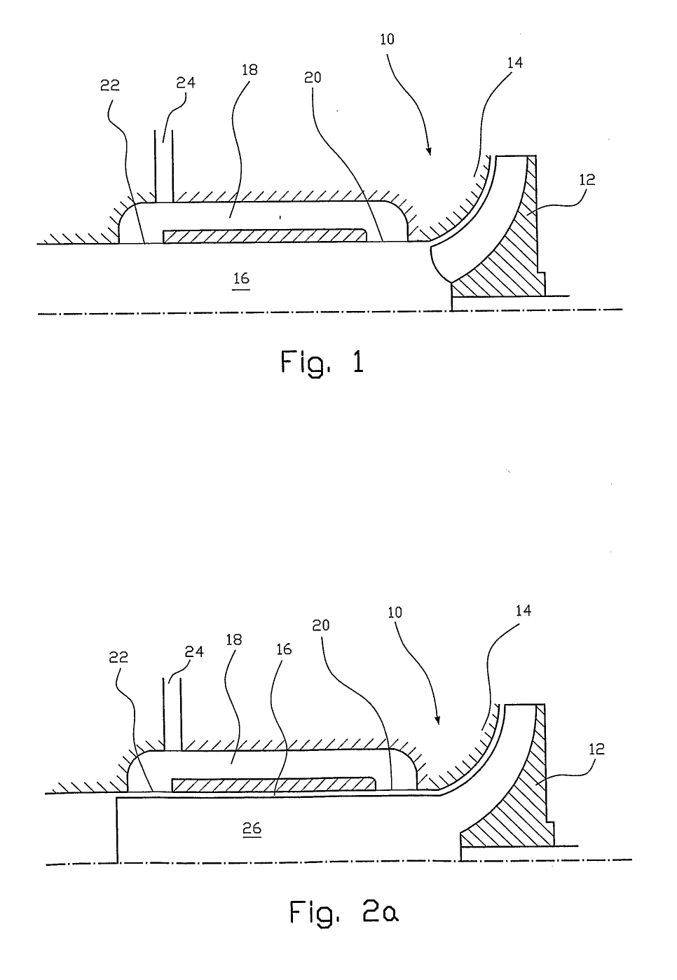

FIG. 1 is a schematical view of a feeding apparatus in accordance with a preferred embodiment of the invention;

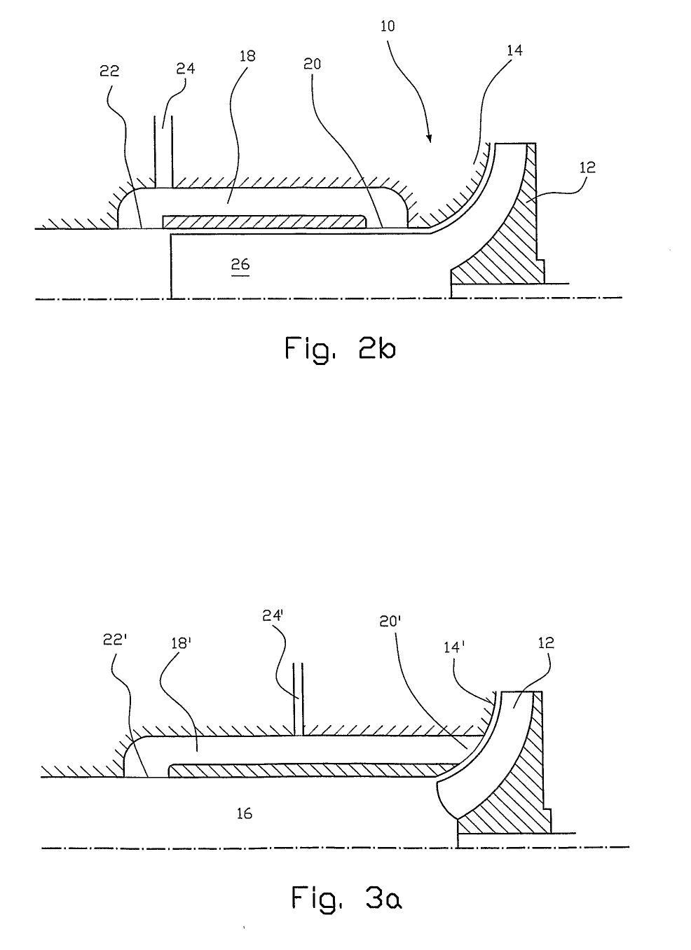

FIGS. 2a and 2b are schematical views of two modifications of a feeding apparatus in accordance with a second preferred embodiment of the invention;

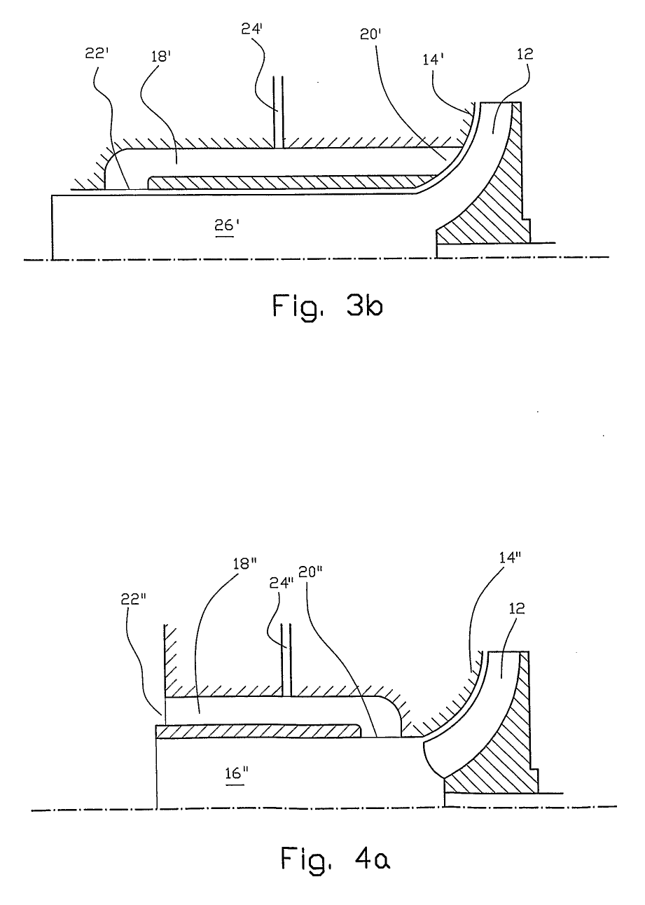

FIGS. 3a and 3b are schematical views of two modifications of a feeding apparatus in accordance with a third preferred embodiment of the invention;

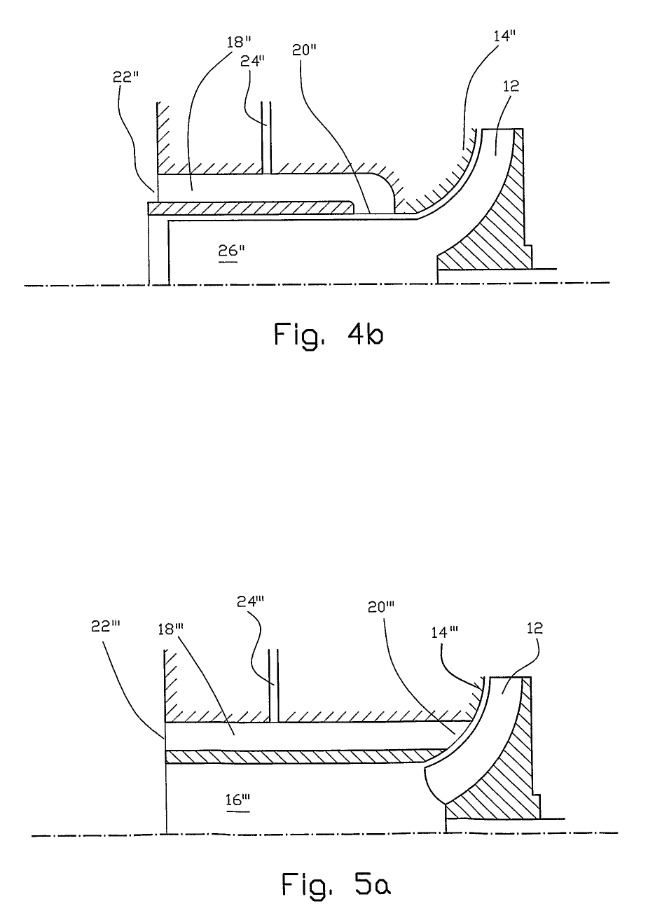

FIGS. 4a and 4b are schematical views of two modifications of a feeding apparatus in accordance with a fourth preferred embodiment of the invention;

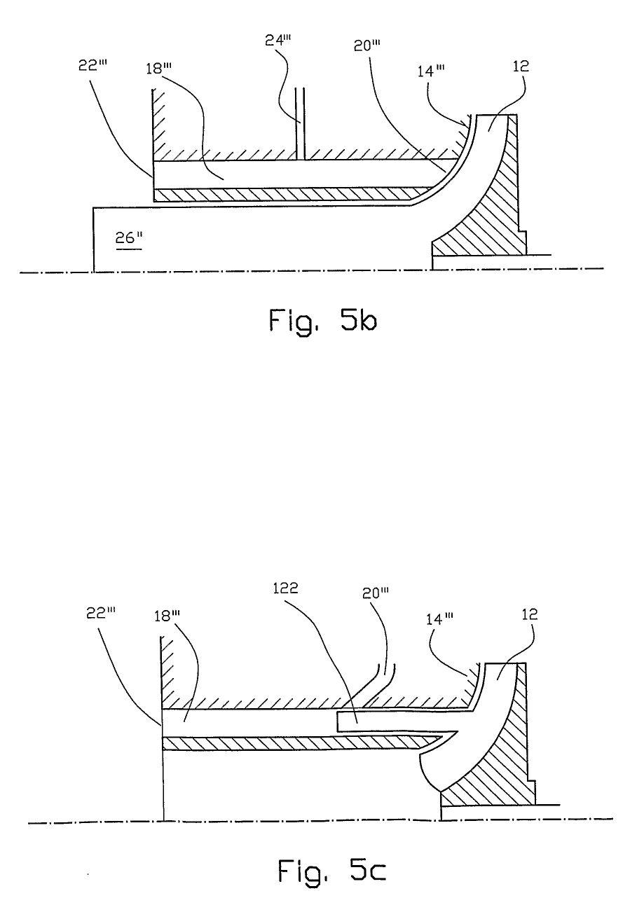

FIGS. 5a, 5b and 5c are schematical views of three modifications of a feeding apparatus in accordance with a fifth preferred embodiment of the invention, the modifications differing from each other to a certain extent; and

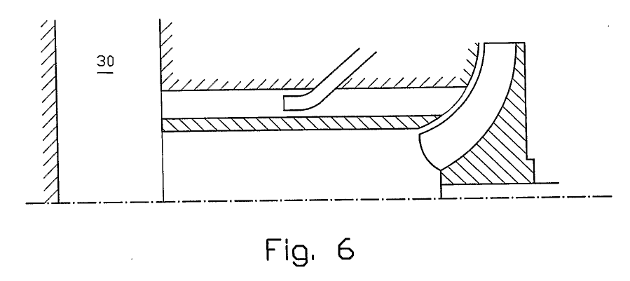

FIG. 6 is a schematical view of a feeding apparatus in accordance with a sixth preferred embodiment of the invention.

FIG. 1 schematically illustrates an apparatus in accordance with a preferred embodiment of the invention for feeding a second medium into a first medium when it is flowing in a suction duct of a centrifugal pump. The apparatus comprises a conventional centrifugal pump 10 with an impeller 12, a volute 14 and a suction duct 16 connected to the volute. As a new solution suggested here is a recirculation duct 18, an inlet opening 20 of which is closer to the impeller 12 than an outlet opening 22. Furthermore, at some point of the length of the recirculation duct 18 there is arranged an inlet conduit 24 for a second medium to be fed into a first medium. It is worth mentioning of the suction duct 16 that it does not necessarily have to be completely integrated with the pump volute 14 throughout its whole length, but it may be a separate member its own or for example part of the drop leg or like preceding the pump.

The operation of an apparatus in accordance with the invention is based on the feature already typical of the conventional centrifugal pumps that at least for a large part of their operational area the flow on the surface of the suction duct runs away from the pump. Now, the flow is facilitated by arranging a recirculation duct 18 into communication with the suction duct 16, the inlet opening 20 of which recirculation duct while being positioned closer to the impeller 12 is positioned to the area of higher pressure than the outlet opening 22 of the duct, whereby backflow takes place by itself. At least one reason for the higher pressure of the opening 20 closer the impeller 12, or the volute 14, is the stronger centrifugal force, which again results from the effect of the impeller 12 of the pump, which causes whirling of the first medium flowing towards the pump in the suction duct 16. Said whirling is the faster, the closer the impeller it is. In other words, the centrifugal force and thereby also the pressure is higher right in front of the impeller 12.

Now, when a second medium, such as steam, peroxide, water, oxygen, etc. is supplied from conduit 24 into a first medium (to be exact it is already a medium containing some of the second medium, but for the sake of clarity it is referred to merely as a first medium) back-flowing in channel 18, said second medium flows to the inlet end of the suction duct 16, or at least closer to it, and begins there to rotate/whirl at an increasing velocity with the first medium ending finally to the pump 10, where eventually the turbulence caused by the vanes of the impeller 12 of the pump mixes the second medium evenly into the first medium.

The apparatus in accordance with the invention is especially suitable for mixing steam into a first medium, which may preferably be a low consistency (consistency 0-6%) or medium consistency (6-25%) fiber suspension of wood processing industry, because steam, as known, requires some time to condense and the disclosed mixer allows the steam time to condense. Moreover, the steam is mixed into a medium in a rotating, but at the same time in a turbulent state, whereby the steam mixes well already because of the mere turbulence. Further, since the steam is supplied to the outer rim of the rotating medium, the steam tends to move towards the center of the flow owing to the centrifugal force affecting the pulp with a higher specific gravity, which also facilitates the mixing of the steam throughout the medium.

FIGS. 2a and 2b illustrate an apparatus in accordance with a second preferred embodiment of the invention for mixing a second medium into a first medium. In fact, the apparatus in accordance with FIGS. 2a and 2b differs from the apparatus of FIG. 1 only in that in FIGS. 2a and 2b a rotor 26, which may be, for example, structurally similar to the one illustrated in U.S. Pat. No. 6,551,054 and extends into the suction duct, is connected to the impeller 12 of the apparatus. In addition to the type disclosed in FIGS. 2a and 2b, i.e. being attached to the impeller 12, the rotor may also be provided with a separate drive of its own, if it is seen necessary in some cases. The rotor 26 may be, for example, either a conventional fluidizing rotor being used for pumping medium consistency pulp, it may be some kind of an inducer, which has no substantial fluidizing effect throughout the whole length of the suction duct, or it may be a suitable combination of the above mentioned structures, only to mention a few advantageous alternatives. The rotor 26 may, of course, be also an apparatus merely aiming at effective mixing taking place in the suction duct, if it is considered that the mixing effect of the impeller 12 to the pulp is not effective enough or it does not last long enough.

FIGS. 3a and 3b illustrate an apparatus in accordance with a third preferred embodiment of the invention for mixing a second medium into a first medium. As can be seen in the figures, the inlet opening 20′ of the recirculation duct 18′ is now located, unlike in FIGS. 1, 2a and 2b, in the volute 14 of the pump farther from the axis of the pump, whereby also the inlet pressure of the first medium back to the recirculation duct 18′ is higher. At the same time also the amount of the recirculating first medium increases provided the size of the channel 18′ remains the same. The increased flow may be utilized, for example, by mixing more second medium to the flow. On the other hand, it is possible to arrange a valve in connection with the recirculation duct 18′, by means of which valve the recirculation is controlled.

Naturally it is also possible to use in connection with the embodiment illustrated in FIG. 3a a rotor arrangement illustrated in FIGS. 2a and 2b or other suitable rotor arrangement, if such is desired, as is disclosed in FIG. 3b. Similarly, in all embodiments it is possible to use several recirculation ducts, whereby they will preferably, but not necessarily be located evenly around the suction duct.

FIGS. 4a and 4b illustrate an apparatus in accordance with a fourth preferred embodiment of the invention. It is typical of this embodiment that recirculation duct 18″ initiating (20″) in the suction duct 16″ discharges the recirculated first medium, into which the second medium is added via conduit 24″, to the outside of the end of the suction duct 16″, for example, to the drop leg or like.

The apparatus in accordance with FIG. 4b differs from the apparatus of FIG. 4a in that a rotor 26″ connected to the impeller 12 is arranged within the suction duct in FIG. 4b. The rotor 26″ may be of its length either as the one disclosed in the figure or shorter or longer than that. Similarly, the rotor may be, as in other embodiments of the invention, also provided with a separate drive, whereby it is naturally not attached to the impeller 12 of the pump.

FIGS. 5a, 5b and 5c illustrate an apparatus in accordance with a fifth preferred embodiment of the invention. It is characteristic of the apparatuses of the figures that the recirculation duct 18″ has its origin already in the volute 14′″ of the pump, in other words farther from the axis of the pump than, for example, in the embodiments of FIGS. 2a, 2b, 4a and 4b. Furthermore, as already earlier, it is possible to locate in the suction duct of the pump a rotor of desired length, which rotor may be run by means of a drive common with or separate from the impeller. FIG. 5c illustrates yet another specific feature of this embodiment, in other words an auxiliary blade 122 mounted to the impeller of the pump, and extending to some extent in the recirculation duct 18′″. This naturally requires that said duct 18′″ is at least for the axial length of the auxiliary blades 122 annular. It is also clear that such auxiliary blades may be applied in the arrangements illustrated in FIGS. 3a and 3b. The purpose of the auxiliary blade/auxiliary blades 122 is both to keep the recirculation duct 18′″ clean at least for the length of the blades, in other words prevent the sticking of solids or like to the walls of the duct 18′″ and to maintain turbulence as deep in the duct 18′″ as possible, and when so desired, pump first medium into the duct 18′″.

Moreover, it is clear that if so desired, it is possible to arrange in the rotor in the suction duct of the structures shown in FIGS. 2b and 4b a portion of the rotor to extend into the recirculation ducts. Thereby, however, it would be necessary to make special arrangements with the rotor and/or suction duct, but such would be easily realized, if they would be reasoned.

FIG. 6 illustrates an apparatus in accordance with a sixth preferred embodiment of the invention, which apparatus is connected with a conventional drop leg 30 either in such a way that the suction duct of the pump is so long that it extends directly to the wall of a drop leg 30 so that a conduit of a desired length is made to the wall of the drop leg, to which the suction duct of the pump is connected by means of special intermediary pipe or so that said conduit of the drop leg is so long that it extends up to the of the impeller of the pump.

The above disclosed and also other recirculation ducts within the scope of the invention are preferably located directly as a part of the suction duct, especially when the suction duct is manufactured as a cast unit. The recirculation duct(s) may, when so desired, be arranged more or less winding round the suction duct, whereby the length of the duct/ducts can be used to control the time the first medium remains in the channel. For example, when mixing steam it would be preferable that the steam would have as much time as possible to condense already in the recirculation duct. In fact when fiber suspension is concerned, it must be taken into consideration that the higher the consistency of the pulp to be recirculated is the more straight and better designed the recirculation duct should be so that the thick pulp will not clog the duct.

In addition to the above-disclosed alternative it is naturally possible to arrange one or more recirculation ducts also as a member separate from the suction duct, which members are merely connected with the conduits in the suction duct or in the suction duct and the pump volute.

Further, it is worth noting that when the second medium to be mixed is steam, it is advantageous to feed the steam as close to the inlet flow opening of the recirculation duct as possible so that time remains for the steam to condense to the first medium already prior to the discharge of the mixture of the recirculated medium and steam into the first medium. Similarly it is possible to arrange more feed points of the second medium over the length of the recirculation duct, whereby in some cases it is possible to feed to some extent more second medium into the first medium.

Finally it is worth noting that the impeller of the pump is illustrated in the drawing figures either without a so-called fluidizing rotor or with it. The figures do not, however, illustrate any specific structure of the fluidizing rotor, because a rotor structure may be chosen for each application according to the need in question, whereby the rotor structures can vary considerably from each other. Thus it is clear that in some applications it is advantageous that the rotor extends outside the suction duct in the longitudinal direction thereof, in some cases the fluidization within the suction duct is sufficient. Correspondingly, in some cases it is necessary to arrange fluidization over the entire length of the suction duct, in some cases only over a part thereof. Thus, in some cases an area may remain between the rotor and the impeller, which is pierced only by the shaft of the rotor. Thereby, also the inlet opening of the recirculation duct may in some applications be located at said shaft.

As can be seen from the above description, a new kind of apparatus has been developed replacing in many situations the prior art mixers, which apparatus replaces the prior pump-mixer combinations. With reference to the above description it should be understood that although only some of the preferred embodiments and in fact only one application are disclosed above, it is possible to use the construction also for other applications suitable for the feeding apparatus and modify both the field of use and the structure of the invention so that the accompanying patent claims alone define the scope of the present invention.

1. A method of mixing a second medium into a first medium, in which method said first medium is allowed to flow along a suction duct (16) into a centrifugal pump (10), where the pressure of the medium is raised and the medium is discharged from the pump (10), characterized in that a side flow is taken from said first medium, which side flow is recirculated and into which second medium is fed in such a manner that said side flow and second medium are fed into said first medium prior to taking said side flow from said first medium in view of the main flow direction of said first medium.

2. Method in accordance with claim 1, characterized in that said side flow is recirculated due to the pressure conditions in the suction duct (16) of the pump.

3. Method in accordance with claim 1, characterized in that said side flow is taken from the pump (10) at a point where the pressure of said first medium is higher than at a point where said side flow is returned to the flow.

4. Method in accordance with claim 1, characterized in that said side flow is taken from the suction duct (16, 16′, 16″) of said pump (10).

5. Method in accordance with claim 1, characterized in that said side flow is taken from the volute (14, 14′, 14″, 14′″) of the pump (10).

6. Method in accordance with claim 1, characterized in that said first medium is low or medium consistency fiber suspension of wood processing industry.

7. Method in accordance with claim 1, characterized in that said second medium to be mixed is steam.

8. An apparatus for feeding a second medium into a first medium, said apparatus comprising a centrifugal pump (10) with an impeller (12), a volute (14) and a suction duct (16) as well as an inlet conduit (24) for said second medium, characterized in that said suction duct (16, 16′, 16″) and/or a front wall of said volute (14, 14′, 14″, 14″) is provided with a recirculation duct (18, 18′, 18″, 18′″) for a first medium, in which recirculation duct (18, 18′, 18″, 18′″) said inlet conduit (24, 24′, 24″, 24′″) is located.

9. Apparatus in accordance with claim 8, characterized in that said recirculation duct (18, 18′, 18″, 18′″) has an inlet opening (20, 20′, 20″, 20′″) and an outlet opening (22, 22′, 22″, 22′″), of which said outlet opening (22, 22′, 22″, 22′″) is farther from said volute (14, 14′, 14″, 14″) of the pump.

10. Apparatus in accordance with claim 8, characterized in that said inlet opening (20, 20′, 20″, 20′″) is located in the area of said suction duct (16, 16″. 16′″).

11. Apparatus in accordance with claim 8, characterized in that said inlet opening (20, 20′, 20″, 20′″) is located in the area of said volute (14).

12. Apparatus in accordance with claim 8, characterized in that said inlet opening (20, 20′, 20″, 20′″) is located at a greater diameter than said outlet opening (22, 22′, 22″, 22′″).

13. Apparatus in accordance with claim 8, characterized in that said outlet opening (22, 22′, 22″, 22′″) is located at a greater diameter than said inlet opening (20, 20′, 20″, 20′″).

14. Apparatus in accordance with claim 8, characterized in that in said suction duct (16, 16′, 16″) of said centrifugal pump there is positioned a rotor (10) rotating therein.

15. Apparatus in accordance with claim 8, characterized in that an apparatus (122) rotating about the axis of the pump is located in said recirculation duct (18, 18′, 18″, 18′″).

16. Apparatus in accordance with claim 8, characterized in that said apparatus (122) rotating about the axis of the pump in said recirculation duct (18, 18′, 18″, 18′″) is part of said rotor (26, 26′, 26″, 26′″) or impeller (12).

17. Apparatus in accordance with claim 8, characterized in that said rotor (26, 26′, 26″, 26′″) is connected to said impeller (12).

18. Apparatus in accordance with claim 8, characterized in that said rotor has a separate drive of its own.
